(19) United States
(12) Patent Application Publication
(10) Pub. No.: US 2007/0222894 A1
(43) Pub. Date: Sep. 27, 2007

(54) Enhanced Video Based Surveillance System

(76) Inventors: Gregory Cox, Kirkland, WA (US); Colin Andrew, Randpark Ridge (ZA)

Correspondence Address: LAHIVE & COCKFIELD, LLP, ONE POST OFFICE SQUARE, BOSTON, MA, 02109-2127, US

(21) Appl. No.: 10/575,126

(22) PCT Filed: Oct. 11, 2004
(86) PCT No.: PCT/IB04/03302

§ 371 Date: Dec. 5, 2006

(30) Foreign Application Priority Data
Oct. 9, 2003 (ZA) 2003/7895

(51) Int. Cl. H04N 7/173

(52) U.S. Cl. 348/586; 348/E07.069

(57) ABSTRACT

The invention provides an enhanced video based surveillance system for use in the surveillance of a zone. The system firstly comprises the step of generating and storing an initial background image (14) of the zone wherein such image is composed of constant background features. Secondly the stored background image is used to partition incoming video images of the zone into segments visually representative of foreground features (16) and background features respectively. Finally foreground features are digitally enhanced (18) relative to the background features in the images, thereby to attract visual attention to such foreground features. The invention further extends to a video motion detection system incorporating the use of stereo calibrated digital cameras.

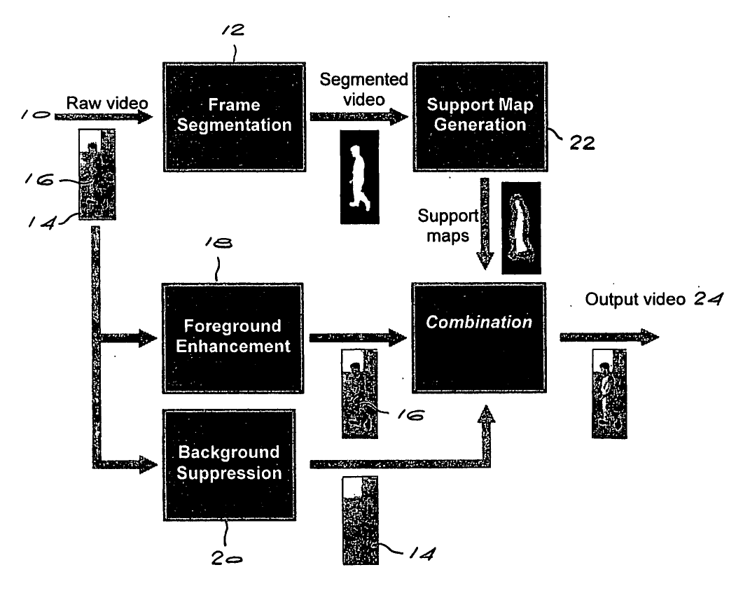

### BACKGROUND TO THE INVENTION

THIS invention relates to an enhanced video based surveillance system. Conventional first-generation video surveillance systems or analogue CCTV (closed circuit television) surveillance systems usually make use of a number of video cameras and communication links to transfer camera-captured analogue images to remote video monitors where they can be observed by human operators or to video image recordal equipment which records them for subsequent viewing by human operators. Such systems are entirely reliant upon the operator's ability to discern, from the images viewed, whether a particular event has taken place and whether any particular action is required.

Digital technology has led to the introduction of second-generation video surveillance systems. Compared to first-generation analogue systems, digital systems can improve the capture, transfer and production of images. In addition they provide low-levels of machine intelligence, such as automatic video motion detection.

In more recent times, almost exclusively digital, third-generation surveillance systems have become available, and offer a higher level of intelligence, for example automatic tracking of specified objects and/or analysis of events in an area under surveillance. Examples of commercially available third-generation video surveillance systems are the Sedor™, Perceptrak™, CAS™ and CCTVware™ systems. Each of these systems is designed for specific surveillance applications, generally of a security control nature.

Some of these known second and third generation surveillance systems do allow for a measure of image enhancement. However such enhancement generally comprise global enhancements where each complete frame of the video sequence is enhanced using image processing techniques. They may, for instance, involve contrast sketching or histogram equalization methods. In each case, the objective of the enhancement is to improve the overall quality of the picture seen by the surveillance operator.

Accordingly, one object of the invention is to provide for more sophisticated enhancement of the images seen by the surveillance video operator, thereby to draw the operator's attention more specifically to relevant aspects of the video images which he receives.

Even in early first generation surveillance systems, automatic motion detection was used. In these systems, two-dimensional zones were defined with the imaged scene and motion within the defined zones could be used to trigger an alarm in order to initiate subsequent action. For example, systems are known in which movement of a person in a pre-defined zone of an imaged scene from a camera not currently being monitored by an operator will automatically switch the view of the relevant camera through to the operator.

Despite these features, the known video motion detection systems gave rise to numerous false alarms. A false alarm could, by way of example, be generated as a result of parallax or perspective effects e.g. where the defined zone in the image is an access doorway and the objective is to detect movement through the door. However as a result of parallax effects, an alarm could be generated by a person moving in front of the door, i.e. penetrating the two dimensional pre-defined zone, even though no movement has actually taken place through the door.

It is accordingly another object of the invention to address these problems with intelligent video motion detection.

### SUMMARY OF THE INVENTION

According to a first aspect of the invention there is provided an enhanced video based surveillance system for use in the surveillance of a zone, the system comprising the steps of:
generating and storing an initial background image of the zone, such image being composed of constant background features,
using the stored background image to partition incoming video images of the zone into segments visually representative of foreground features and background features respectively, and
digitally enhancing foreground features relative to the background features in the images, thereby to attract visual attention to such foreground features.

Foreground features may for instance include objects and/or persons imposed in the derived images on the constant, stored background image.

The digital enhancement step may, for instance, include highlighting, colour tinting or colour outlining of foreground features. Alternatively or in addition, this step may include suppression of the background image by colour suppression or removal, blurring or the like.

The invention envisages that digital enhancement may be applied to all foreground features, or alternatively to only some, or even a single, foreground feature(s). As a further alternative, only foreground features in specified zones may be enhanced.

As yet another alternative, the enhancement summarized above may be implemented in conjunction with a video motion detection system such that motion-related foreground features only are digitally enhanced.

According to another aspect of the invention there is provided a video motion detection system comprising the steps of sub-dividing a three-dimensional zone which is to be monitored into a plurality of three-dimensional sub-zones, and automatically monitoring motion in at least one sub-zone by means of stereo calibrated digital cameras arranged to view the sub-zone(s).

This system may be used in conjunction with the system according to the first aspect of the invention, such that motion in a foreground segment is digitally enhanced relative to the background image, thereby to draw visual attention to such motion.

### BRIEF DESCRIPTION OF THE DRAWING

The invention will now be described in more detail, by way of example only, with reference to the accompanying block diagram illustrating the principles underlying the first aspect of the invention.

### SPECIFIC DESCRIPTION

A first aspect of the invention provides for targeted digital enhancement of surveillance video images, with the objective of drawing an operator's attention more specifically to relevant features in those images. Such surveillance may primarily be for security purposes, for example to combat theft of goods from the zone but it may also be used in non-security applications.

In the first aspect of the invention, a background image, i.e. digital model, of a scene viewed by a surveillance camera is generated. This image is representative of a constant background in the zone viewed by the camera. With reference to the drawing, the background image or model serves as a reference for subsequent partitioning or segmentation of incoming raw video data 10, in a segmentation step 12, into segments representative of foreground and background features respectively. In the drawings, the raw video data includes the constant background 14, composed of background features, and a foreground segment including a person 16 superimposed as a foreground feature on the background 14. The foreground segment could alternatively or in addition include other features not forming part of the background, such as objects which have been added to or removed from the scene or moved from one location to another in the scene.

In accordance with a next step in this aspect of the invention, targeted digital enhancement techniques are carried out on the respective segments to highlight the foreground segment. In the example represented by the drawing, the foreground segment is enhanced and the background segment is simultaneously suppressed. Foreground segment enhancement, indicated by the block 18 in the drawing, may for example involve highlighting, colour tinting or colour outlining of the foreground segment, namely the foreground feature, i.e. the person 16. Background suppression, indicated in the drawing by the block 20, may for example involve colour suppression, colour removal, brightness suppression or relative blurring of background features.

Foreground segment enhancement 18 and/or background segment suppression 20 has the effect of visually enhancing the foreground features, i.e. the person 16, relative to background features in the video image which is viewed by an operator. This in turn has the desirable effect of drawing the operator's attention to the foreground feature(s) in question.

The block 22 in the drawing represents a step, referred to as support map generation, in which, for each foreground feature of interest, a limited area or support map containing the foreground feature(s) in question are identified. The enhancement and suppression steps are then performed with reference to the identified area(s). This results in the production of a final output video 24 in which the foreground feature of interest, i.e. the person 16 in this example, is visually enhanced relative to the constant background segment.

The digital enhancement technique described above may be applied in a number of different ways. In a first alternative, targeted enhancements are applied to the entire imaged scene. In this case all foreground features, for example all persons, moved or introduced objects etc are visually enhanced and thereby brought to the attention of the operator. In this case, the attention of the operator is simultaneously drawn to all foreground segment features.

In a second alternative, targeted enhancement is applied only to foreground features in manually defined sub-zones within the total image. For example, in a security application, sub-zones surrounding a high-risk area could be manually defined, with digital enhancement only being applied to foreground features within the specified sub-zones. Features which are classified in the image segmentation step 12 as forming part of the foreground segment, and which fall within a specified sub-zone, are then enhanced while other features falling outside any specified sub-zone, even though assigned to the foreground segment during the segmentation step, are not enhanced. In this way, the operator's attention can be drawn to foreground features in the specified high-risk sub-zones and there is less chance of the examiner's attention being distracted by foreground segment features occurring outside the high-risk sub-zones. Foreground segment features outside the specified high-risk sub-zones are accordingly suppressed relative to foreground segment features in the high-risk sub-zones, although they may still be visible to the operator.

In a second alternative the different targeted video enhancement techniques described above could also be applied in conjunction with video motion detection. Typically a surveillance operator will be required to monitor a number of scenes captured by different cameras. In accordance with known two-dimensional video motion detection techniques, motion of a person or object within a predefined zone from a camera not currently monitored by the operator can result in that camera being switched through automatically to the operator, thereby ensuring that the operator is watching the scene in which the detected motion is taking place.

In accordance with this alternative the visual enhancement techniques of the invention can be applied to concentrate the attention of the operator even more specifically to a motion event. For example, motion of a person or object within a specified high-risk sub-zone could in the first instance result in the relevant camera being switched through to the operator and in the second instance in image enhancement of the person or object, as a foreground segment feature within a designated sub-zone. In this way, the operator's attention is drawn immediately to the person or object which is moving in the specified high-risk sub-zone, rather a person who may be in another zone.

Video motion detection techniques, as referred to above, have conventionally been confined to two dimensional video images. However, as explained previously, two-dimensional video detection can give rise to false alarms as a result, for instance, of parallax or perspective effects. So, for instance, where motion is detected in a two-dimensional imaging system in which an operator is required to monitor images produced by numerous cameras each viewing different scenes, resulting in switching of the image of the motion-detecting camera to the operator, adverse parallax or perspective effects may still result in a false “alarm” i.e. incorrect switching or the camera in question.

This problem is addressed by a second aspect of the invention which proposes the use of stereo calibrated cameras to monitor motion within specified three-dimensional zones. In this case, although the operator will still view two-dimensional video images, combined information from stereo calibrated cameras will ensure that camera switching will only take place where motion has taken place within a specified three-dimensional zone. Referring to the previously cited example of a system in which it is desired to monitor motion through a doorway, the combined information from the stereo cameras will ensure that the “alarm”, i.e. the switching of the relevant cameras, will only take place where movement through the doorway, in a three-dimensional sense, has taken place. It is believed that the use of three-dimensional imaging in this way can reduce the frequency of false alarms in a video motion detection system.

Conventional two-dimensional video motion detection systems rely on a pixel-based approach in which varying pixel intensities provide an indication of motion. However this can again give rise to false alarms in that pixel intensity could vary as a result of other factors, for example ambient lighting. This aspect of the invention addresses this potential problem by proposing an object-based approach in which the characteristics of certain objects, for example persons, are taken into account to provide a more reliable “alarm” or camera switching in the event of motion penetration of a specified sub-zone.

It is envisaged that the video enhancement aspect of the invention could be combined with the three-dimensional video motion detection aspect. So, for instance, detection of motion in a high-risk zone, for example through a doorway, could be combined with visual enhancement of the relevant foreground segment feature, e.g. of a person moving in the high-risk zone.

1. An enhanced video based surveillance method for use in the surveillance of a zone, the method comprising the steps of:
generating and storing an initial background image of the zone, the background image being composed of constant background features,
using the background image to partition incoming video images of the zone into segments visually representative of foreground features and background features respectively, and
digitally enhancing the foreground features relative to the background features in the images, thereby to attract visual attention to the foreground features.

2. An enhanced video based surveillance method according to claim 1 wherein the foreground features include objects or persons imposed in the images on the background image.

3. An enhanced video based surveillance method according to claim 1 wherein the digital enhancement step further comprises highlighting, color tinting or color outlining of the foreground features.

4. An enhanced video based surveillance method according to claim 1 wherein the digital enhancement step further comprises suppression of the background image by color suppression, color removal, brightness suppression or relative blurring of the background features.

5. An enhanced video based surveillance method according to claim 1 wherein the digital enhancement is applied to the foreground features.

6. An enhanced video based surveillance method according to claim 1 wherein the digital enhancement is applied to only a single foreground feature.

7. An enhanced video based surveillance method according to claim 1 wherein digital enhancement is applied only to foreground features in specified sub-zones.

8. An enhanced video based surveillance method according to claim 1 wherein the digitally enhancing step is implemented in conjunction with a video motion detection system such that motion-related foreground features only are digitally enhanced.

9. An enhanced video based surveillance method according to claim 1 further comprising the steps of sub-dividing a three-dimensional zone which is to be monitored into a plurality of three-dimensional sub-zones, and automatically monitoring motion in at least one sub-zone with one or more stereo calibrated digital cameras arranged to view the sub-zones.

10. (canceled)
